(19) United States
(12) Patent Application Publication
(10) Pub. No.: US 2020/0195029 A1
(43) Pub. Date: Jun. 18, 2020

(54) CHARGE CONTROL DEVICE, CHARGE CONTROL METHOD, NON-TRANSITORY COMPUTER READABLE MEDIUM, CONTROL CIRCUIT AND POWER STORAGE SYSTEM

(71) Applicant: KABUSHIKI KAISHA TOSHIBA, Minato-ku (JP)

(72) Inventors: Yumi FUJITA, Chuo (JP); Tomokazu Morita, Funabashi (JP); Nobukatsu Sugiyama, Kawasaki (JP)

(73) Assignee: KABUSHIKI KAISHA TOSHIBA, Minato-ku (JP)

(21) Appl. No.: 16/801,279

(22) Filed: Feb. 26, 2020

Related U.S. Application Data
(63) Continuation of application No. PCT/JP2019/008382, filed on Mar. 4, 2019.

(30) Foreign Application Priority Data
Aug. 8, 2018 (JP) 2018-149735

(51) Int. Cl. H02J 7/00

(52) U.S. Cl. CPC H02J 7/0049; H02J 7/0042; H02J 7/0071

(57) ABSTRACT

A charge control device as an embodiment of the present invention includes a charge controller and a determiner. The charge controller controls charging of a secondary battery. The determiner determines whether or not the secondary battery is being used in charging of the secondary battery. When it is determined that the secondary battery is being used, the charge controller stops charging of the secondary battery before the secondary battery is fully charged.

### CROSS-REFERENCE TO RELATED APPLICATION(S)

This application is a Continuation of International Application No. PCT/JP2019/008382 filed on Mar. 4, 2019, the entire contents of which are hereby incorporated by reference.

### FIELD

An embodiment relates to a charge control device, a charge control method, a program, a control circuit, and a power storage system.

### BACKGROUND

Nonaqueous electrolyte secondary batteries such as lithium ion batteries are widely used for electronic devices such as smartphones. For such reasons as consuming a large amount of power, these electronic devices are often used while being charged. However, deterioration of the secondary batteries tends to be hastened when their SOC (state of charge) is maintained close to 100%. Particularly, repeated use of batteries in charging may cause rapid capacity degradation and even cause expansion of battery packs or the like. Therefore, there is a demand for techniques capable of preventing deterioration due to use of batteries in charging.

### BRIEF DESCRIPTION OF THE DRAWINGS

FIG. 1 is a block diagram illustrating an example of a schematic configuration of a power storage system provided with a charge control device according to an embodiment of the present invention;

FIG. 2 is a graph illustrating an example of characteristic of a secondary battery;

FIG. 3 is a graph illustrating an example of transitions of voltage and temperature of a storage battery in charging when using an existing power storage system;

FIG. 4 is a graph illustrating an example of transitions of voltage and temperature of a storage battery in charging in a power storage system according to the present embodiment;

FIG. 5 is a flowchart illustrating an example of processing flow until an SOC upper limit value is determined;

FIG. 6 is a flowchart illustrating an example of flow of a battery characteristics calculation process;

FIG. 7 is a flowchart illustrating an example of flow of a battery characteristics calculation process;

FIGS. 8A and 8B are a graph illustrating an example of a relationship between a charge amount and an open circuit voltage (charge amount-OCV curve);

FIG. 9 is a graph illustrating an example of a relationship between an SOC and an open circuit voltage (SOC-OCV curve);

FIG. 10 is a flowchart illustrating an example of a charge control processing flow by the charge controller; and

FIG. 11 is a block diagram illustrating an example of a hardware configuration according to an embodiment of the present invention.

### DETAILED DESCRIPTION

As an embodiment of the present invention, we provide a device that prevents deterioration of a secondary battery due to usage of the secondary battery in charging by controlling charging of the secondary battery being used while being charged.

A charge control device as an embodiment of the present invention includes a charge controller and a determiner. The charge controller controls charging of a secondary battery. The determiner determines whether or not the secondary battery is being used in charging of the secondary battery. When it is determined that the secondary battery is being used, the charge controller stops charging of the secondary battery before the secondary battery is fully charged.

An embodiment will be explained in detail below with reference to the accompanying drawings. The present invention is not limited to the embodiment.

### (An Embodiment of the Present Invention)

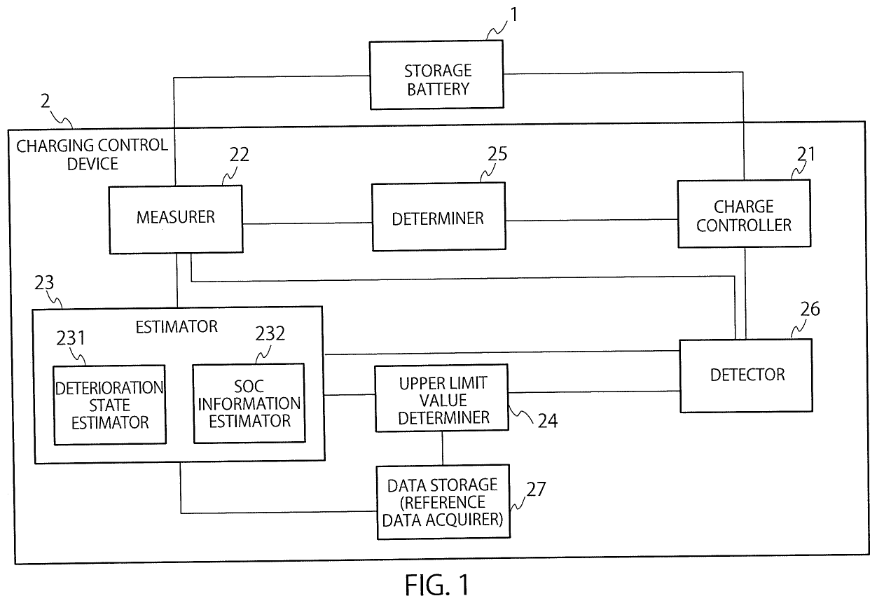

FIG. 1 is a block diagram illustrating an example of a schematic configuration of a power storage system provided with a charge control device according to an embodiment of the present invention. The present power storage system includes a storage battery 1 and a charge control device 2. The charge control device 2 includes a charge controller 21, a measurer 22, an estimator 23, an upper limit value determiner 24, a determiner 25, a detector 26, and a data storage (reference data acquirer) 27. The estimator 23 includes a deterioration state estimator 231 and an SOC information estimator 232.

The storage battery 1 and the charge control device 2 have been described separately in the example in FIG. 1, but one storage battery (storage battery apparatus) provided with the charge control device 2 may be adopted by implementing the charge control device 2 using a CPU, a control circuit or the like and furnishing the storage battery 1 with the charge control device 2. Furthermore, by installing a program in a device such as a laptop computer or a smartphone using the storage battery 1, the device may be implemented as the charge control device 2.

The storage battery 1 is a secondary battery to be charged by the charge control device 2. The storage battery 1 is assumed to be a nonaqueous electrolyte secondary battery such as a lithium ion battery, a battery pack of the nonaqueous electrolyte secondary batteries, or the like. However, the storage battery 1 is not limited to these batteries, and may be any rechargeable battery. Hereinafter, the term “storage battery” includes a battery pack, battery module, and unit cell unless otherwise noted.

The storage battery 1 may be installed, for example, in equipment such as a cell phone, laptop PC, electric bicycle, hybrid vehicle that uses both electricity and gasoline, or drone. Also, the storage battery 1 may be a stationary storage battery installed for each structure such as a private house, building, or factory. The storage battery 1 may be linked with or interconnected with a power generation system.

The charge control device 2 controls charging of the storage battery 1. Particularly when the storage battery 1 is being used in charging of the storage battery 1, the charge control device 2 recognizes the situation and suppresses charging in the situation. This prevents deterioration of the storage battery 1 from progressing rapidly.

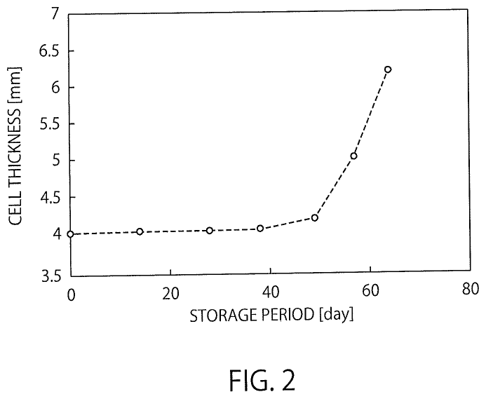

FIG. 2 is a graph illustrating an example of characteristic of a secondary battery. The graph shown in FIG. 2 illustrates a change in thickness of a lithium battery (cell thickness) in a case where a secondary battery, an SOC (state of charge) of which is 100%, that is, a fully charged secondary battery is stored in an environment of 45 degree Celsius. It is seen from the graph that the thickness is initially on the order of 4 mm but expands drastically when approximately 50 days pass. Thus, it is known that deterioration of secondary batteries having a high temperature and a high SOC progresses rapidly.

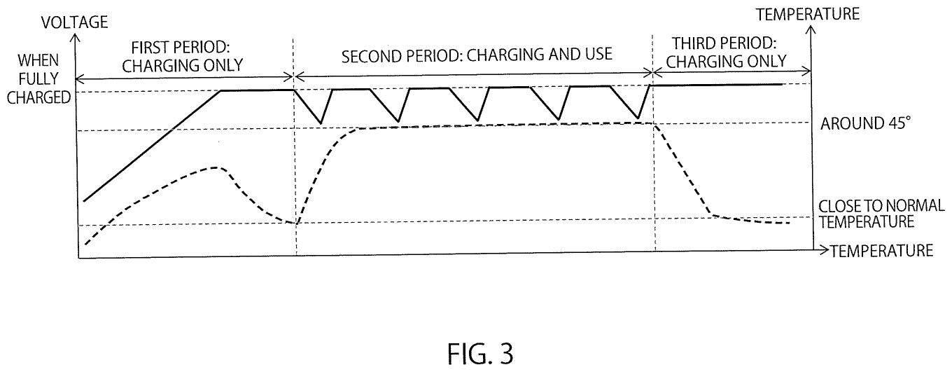

FIG. 3 is a graph illustrating an example of transitions of voltage and temperature of a storage battery in charging when using an existing power storage system. A solid line graph indicates a voltage of the storage battery 1 and a broken line graph indicates a temperature of the storage battery 1. The voltage and the SOC have a correlation and the SOC increases as the voltage increases. For that reason, description will be given here using the voltage instead of the SOC. FIG. 3 shows first to third periods. Suppose that charging is performed but the battery is not used during the first and third periods. Suppose that charging and use of the battery are simultaneously performed during the second period.

During the first period, the voltage and temperature of the storage battery 1 increase along with charging of the storage battery 1. Charging is stopped when the storage battery 1 is fully charged, the voltage of the storage battery 1 is kept at a maximum value and neither charging nor use is performed, and so the temperature of the storage battery 1 drops to nearly a normal temperature.

During the second period, the voltage of the storage battery 1 starts lowering with use of the battery, but charging is performed when the voltage drops to a certain degree. In the example in FIG. 3, charging is performed at a time point when the SOC decreases to approximately 95%. In this way, the voltage of the storage battery 1 is returned to the maximum value, but since charging is stopped when fully charged, a voltage drop recurs with use of the battery. Thus, during the second period, the voltage of the storage battery 1 increases and decreases repeatedly. On the other hand, since temperatures also increase with charging or use of the battery, a high temperature state is kept for the second period. In the example in FIG. 3, the temperature is kept around 45 degree Celsius.

For the third period, use of the battery is stopped, and so the voltage of the storage battery 1 remains at the maximum value just like at the time of full charging during the first period, and the temperature drops to around the normal temperature.

Thus, temperature and voltage (that is, SOC) are kept at high levels for such a period during which both charging and use of the battery are performed simultaneously. Hence, deterioration of the storage battery 1 is likely to progress. When convenience for the user is taken into consideration, it is difficult to prohibit use of the battery in charging. Therefore, it is necessary to control for avoiding a state with a high temperature and a high SOC.

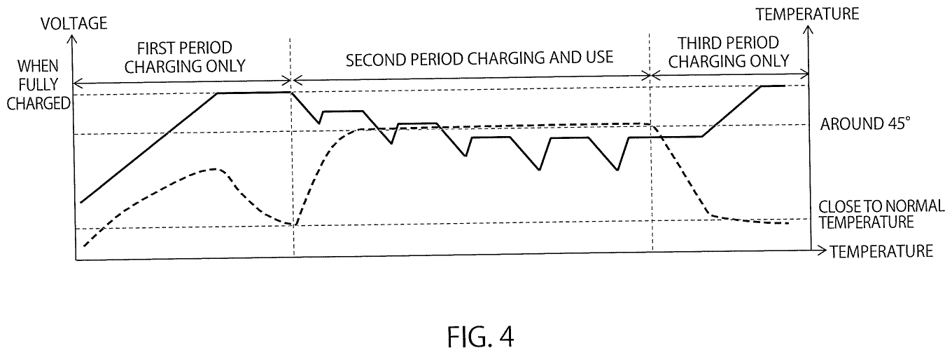

FIG. 4 is a graph illustrating an example of transitions of voltage and temperature of the storage battery 1 in charging in the power storage system according to the present embodiment. A solid line graph indicates a voltage of the storage battery 1 and a broken line graph indicates a temperature of the storage battery 1 just like FIG. 3. For a second period during which charging and use of the battery are simultaneously performed, the battery is not fully charged and charging is stopped. This is because that the charge control device 2 stops charging at a time point at which the SOC reaches an upper limit value if both charging and use of the battery are performed. For a third period during which use of the battery is stopped, charging is resumed so that the battery is fully charged, and the storage battery 1 is fully charged.

As shown in FIG. 4, the temperature of the storage battery 1 rises, but the SOC is suppressed to a low level by this control. For this reason, in the present embodiment, it is possible to suppress deterioration of the storage battery 1 compared to the case where an existing power storage system is used. Incidentally, in the example of FIG. 4, control is performed such that the upper limit value is initially gradually lowered and the upper limit value is not changed in the middle.

In this way, the charge control device 2 stops charging before the battery is fully charged when charging and use of the battery are simultaneously performed. Although only stopping charging before the battery is fully charged has an effect, it is preferable to set an upper limit value of the SOC for which a necessary SOC and risk of deterioration progress are taken into consideration and stop charging at a time point at which the upper limit value of the SOC is reached. Therefore, suppose control is performed based on the upper limit value of the SOC in the present embodiment.

The upper limit value of the SOC may be set in advance. For example, 80% of the SOC may be uniformly set as the upper limit value irrespective of the storage battery 1. However, the upper limit value of the SOC may be preferably changed depending on the state of deterioration and temperature or the like of the storage battery 1. For example, as shown in FIG. 2, since a risk of expansion of the storage battery 1 significantly differs between a storage battery 1 with advanced deterioration and a storage battery 1 without advanced deterioration, it is preferable to lower the upper limit value of the SOC for the storage battery 1 with advanced deterioration compared to the storage battery 1 without advanced deterioration. Thus, the upper limit value of the SOC is determined (changed) according to the storage battery 1 in the present embodiment.

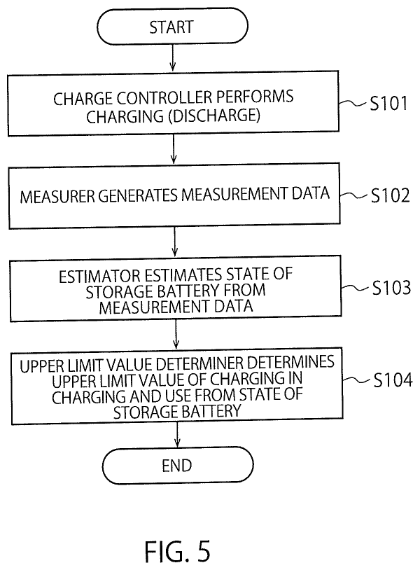

First, a flow of determination of an upper limit value will be described. FIG. 5 is a flowchart illustrating an example of processing flow until an SOC upper limit value is determined. Incidentally, the present flowchart is an example, and order of processing or the like may not be limited as long as necessary processing results can be obtained. The processing results of the respective processes may be successively stored in the data storage 27 or the like and each component may acquire the processing results with reference to the data storage 27. The same applies to subsequent flowcharts.

The charge controller 21 charges the storage battery 1 (S101). Incidentally, the charging may be performed to increase the charge amount of the storage battery 1 or to determine an upper limit value. Incidentally, discharge may be performed instead of charging. The measurer 22 generates measurement data at least indicating a voltage and a current in charging or discharging of the storage battery 1 (S102).

The estimator 23 estimates the state of the storage battery 1 from the measurement data (S103). The upper limit value determiner 24 determines an upper limit value of the SOC during both charging and use based on the state of the storage battery 1 (S104).

Incidentally, the determined upper limit value or state of the storage battery 1 may be outputted by an output device (not shown) to a monitor inside or outside the charge control device 2.

Next, components included in the charge control device 2 and details of the processing will be described.

The charge controller 21 controls charging of the storage battery 1. Charging of the storage battery 1, for example, may be performed using a general method such as constant current and constant voltage charging. Charging of the storage battery 1 is performed when electric energy of the storage battery 1 is replenished and when the state of the storage battery 1 is estimated. Incidentally, the state of the storage battery 1 can be estimated even when electric energy of the storage battery 1 is replenished. Incidentally, it is assumed in the present embodiment that the charge controller 21 starts charging of the storage battery 1 when the charge control device 2 receives an instruction from the user or another system or the like via an input device (not shown).

Furthermore, the charge controller 21 performs control so as to stop charging by receiving an instruction from the detector 26 that detects that the SOC has reached the upper limit value. Furthermore, the charge controller 21 performs control so as to resume charging by receiving an instruction from the determiner 25 that determines to resume charging.

Incidentally, the state of the storage battery 1 can also be estimated from data in discharge. Therefore, the charge controller 21 may control discharge to estimate the state of the storage battery 1. Therefore, unless specifically defined otherwise, “charging” to estimate the state of the storage battery 1 may also be read as “discharge.”

The measurer 22 performs measurement on the storage battery 1 and generates measurement data indicating information on the storage battery 1. Suppose as the information on the storage battery 1, at least a voltage and a current of the storage battery 1 (voltage between a positive electrode terminal and a negative electrode terminal of a unit cell in the storage battery 1 and a current flowing through the unit cell) are included in the measurement data. Incidentally, other information like temperatures of the storage battery 1 and its periphery may also be included. Incidentally, as described above, there are charging for replenishing electric energy of the storage battery 1 and charging for estimating the state of the storage battery 1, and the information included in the measurement data may differ depending on the type of charging.

The estimator 23 performs processing to improve accuracy of SOC estimation by the storage battery 1. Incidentally, when simply charging is stopped before the battery is fully charged, the charge controller 21 needs to stop charging before the voltage shown in the measurement data reaches the voltage at the time of full charging. Therefore, the SOC may not have to be estimated and the estimator 23 may be omitted.

The deterioration state estimator 231 of the estimator 23 estimates a deterioration state of the storage battery 1. More specifically, the deterioration state estimator 231 estimates parameter values of the storage battery 1 with which deterioration of the storage battery 1 can be recognized. The storage battery 1 deteriorates according to the length of time it is used. Therefore, it is possible to recognize deterioration of the storage battery 1 by calculating such parameters relating to the storage battery 1 as to increase or decrease according to the length of time the storage battery 1 is used. For example, an initial charge amount of a positive electrode or a negative electrode; a capacity (mass) of the positive electrode or the negative electrode; a battery capacity; and an open circuit voltage correspond to parameters indicating the deterioration state because their value increases or decreases along with use of the storage battery 1. Thus, there are several parameters that indicate the deterioration state. Which one of parameters should be used to indicate the deterioration state may be determined in advance or selected freely.

A charge curve analysis may be preferably used to estimate the deterioration state of the storage battery 1. For example, a case will be considered where a device using the storage battery 1 is implemented as the charge control device 2. In this case, using a charge curve analysis technique makes it possible to grasp a deterioration state of a battery in use without removing the battery and with high accuracy. That is, it is possible to save time and effort for removing the storage battery 1 from the device and reattaching it to a measuring apparatus for estimation of the state of the storage battery 1. Therefore, parameters indicating the deterioration state are preferably parameters that can be calculated through a charge curve analysis.

However, there is no reason that techniques other than the charge curve analysis cannot be used. A charging/discharging test in which a battery capacity is measured by passing a test current, a current stopping method mainly focusing on measurement of internal resistance values or an electrochemical measurement such as an AC impedance measurement may be used. Alternatively, measurement may be performed by combining these methods.

Internal state parameters and a battery characteristic (cell characteristic) of each unit cell are calculated based on measurement data through a charge curve analysis. More specifically, internal state parameters are estimated based on measurement data. The battery characteristic is estimated based on the estimated internal state parameters. As described above, parameters to be used as indicative of a deterioration state may be determined in advance and the parameters may be calculated through a charge curve analysis.

The internal state parameter represents the internal state of the unit cell. It is assumed that the internal state parameter includes positive electrode capacity (mass of a positive electrode), negative electrode capacity (mass of a negative electrode), an SOC deviation, and internal resistance. The SOC deviation means a difference between an initial charge amount of the positive electrode and an initial charge amount of the negative electrode.

The battery characteristic can be calculated from the internal state parameters, and indicates a characteristic of a voltage or the like of the storage battery 1. The battery characteristic includes a battery capacity, an open circuit voltage (OCV), OCV curve or the like. The internal resistance may also be included in the battery characteristic. The OCV curve means a graph (function) indicating a relationship between a certain index relating to the storage battery 1 and an open circuit voltage. The battery capacity is a capacity within a range from a position where a potential difference between the positive electrode and the negative electrode becomes a discharge end voltage of the battery to a position where the potential difference becomes a charging end voltage of the battery.

It is assumed that expressions, parameters and the like necessary for the charge curve analysis are stored in advance in the data storage 27. For example, a function indicating a relationship between a charge amount of the positive or the negative electrode of the unit cell and a potential is stored therein.

Based on the measurement data, the deterioration state estimator 231 calculates internal state parameters including an amount of an active material making up the positive electrode or negative electrode of the unit cell, an initial charge amount, and the internal resistance of the unit cell. The calculation uses a function of calculating a voltage of the storage battery 1 based on the active material amount and internal resistance. First, using the function, the voltage of the storage battery 1 is calculated based on the measurement data. Then, the active material amount and internal resistance that reduce a difference between the calculated voltage of the storage battery 1 and a voltage in the measurement data are obtained through regression calculation. Incidentally, the positive electrode may be made of plural active materials but in the present embodiment, description will be given by taking as an example a secondary battery in which each of the positive electrode and negative electrode is made of one active material.

When a secondary battery having a positive electrode and a negative electrode each of which is made of one type of active material is charged, a voltage (terminal voltage) “Vt” at time “t” can be expressed by the following Expression.

$$\begin{matrix}[ Expression 1 ] & \\ {V}_{t} = {f}_{c} ( {q}_{0}^{c} + \frac{{q}_{t}}{{M}_{c}} ) - {f}_{a} ( {q}_{0}^{a} + \frac{{q}_{t}}{{M}_{a}} ) + {RI}_{t} & ( 1 )\end{matrix}$$

where “Iₜ” represents a current value at time “t” and “qₜ” represents a charge amount of the secondary battery at time “t”. The term “f_{c}” represents a function indicating a relationship between a charge amount of the positive electrode and a potential, “fₐ” represents a function indicating a relationship between a charge amount of the negative electrode and a potential. The term “qₒ^{c}” represents an initial charge amount of the positive electrode and “M_{c}” represents mass of the positive electrode. The term “qₒ^{a}” represents an initial charge amount of the negative electrode and “Mₐ” represents mass of the negative electrode. “R” represents internal resistance.

A current value included in the measurement data is used for the current value “Iₜ”. The charge amount “qₜ” can be calculated by integrating the current value “Iₜ” with respect to time. Suppose that the function “f_{c}” and the function “fₐ” are recorded in the data storage 27 as function information.

The remaining five values (parameter set) of the initial charge amount “qₒ^{c}” of the positive electrode, mass “M_{c}” of the positive electrode, the initial charge amount “qₒ^{a}” of the negative electrode, the mass “Mₐ” of the negative electrode and the internal resistance “R” are estimated through regression calculation. Incidentally, the amount of active material of each electrode may be calculated assuming that it is a predetermined proportion of mass of each electrode.

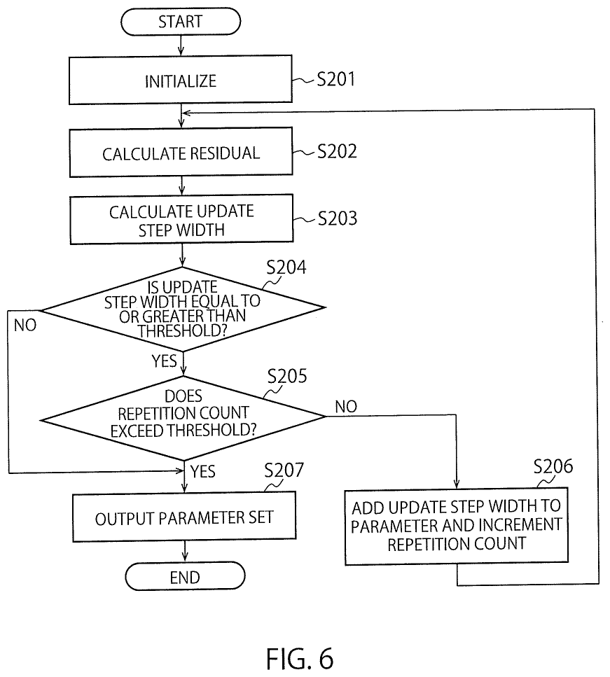

FIG. 6 is a flowchart illustrating an example of an internal state parameter calculation processing flow. The deterioration state estimator 231 performs initialization, sets initial values in the aforementioned parameter set and sets a repetition count of regression calculation to “0” (S201). The initial values may be, for example, values calculated when the previous calculation processing for the amount of active material is performed or estimable values may be used.

The deterioration state estimator 231 calculates a residual E expressed by the following Expression (S202).

$$\begin{matrix}[ Expression 2 ] & \\ E = {\sum }_{t = 0}^{{t}_{end}} {( {V}_{bat\_t} - {V}_{t} )}^{2} = {\sum }_{t = 0}^{{t}_{end}} {( {V}_{bat\_t} - ( {f}_{c} ( {q}_{0}^{c} + \frac{{q}_{t}}{{M}_{c}} ) - {f}_{a} ( {q}_{0}^{a} + \frac{{q}_{t}}{{M}_{a}} ) + {RI}_{t} ) )}^{2} & ( 2 )\end{matrix}$$

where “V_{bat-t}” represents a terminal voltage at time “t” and “t_{end}” represents end time of charging.

The deterioration state estimator 231 calculates an update step width of a parameter set (S203). The update step width of the parameter set can be calculated using, for example, a Gauss-Newton method or a Levenberg-marquardt method or the like.

The deterioration state estimator 231 determines whether or not the scale of the update step width is less than a predetermined scale (S204). When the scale of the update step width is less than the predetermined scale (NO in S204), the deterioration state estimator 231 determines that calculation has converged and outputs the parameter set (S207). When the scale of the update step width is equal to or greater than the predetermined threshold (YES in S204), the deterioration state estimator 231 confirms whether or not a repetition count of regression calculation exceeds a predetermined value (S205).

When the repetition count of regression calculation exceeds the predetermined value (YES in S205), the deterioration state estimator 231 outputs the parameter set (S207). When the repetition count of regression calculation is equal to or below the predetermined value (NO in S205), the deterioration state estimator 231 adds the update step width calculated in S203 to the parameter set and increments by one the repetition count of regression calculation (S206). The flow then returns to the calculation of a residual (S202). This is the flowchart of the calculation processing of internal state parameters.

The deterioration state estimator 231 further calculates a battery characteristic from the internal state parameters. As an example, a case will be described where an open circuit voltage which is a battery characteristic of the storage battery 1 is calculated. The deterioration state estimator 231 calculates a relationship between the charge amount and the open circuit voltage of the storage battery 1 using the calculated initial charge amount “qₒ^{c}” of the positive electrode, mass “M_{c}” of the positive electrode, initial charge amount “qₒ^{a}” of the negative electrode and mass “Mₐ” of the negative electrode.

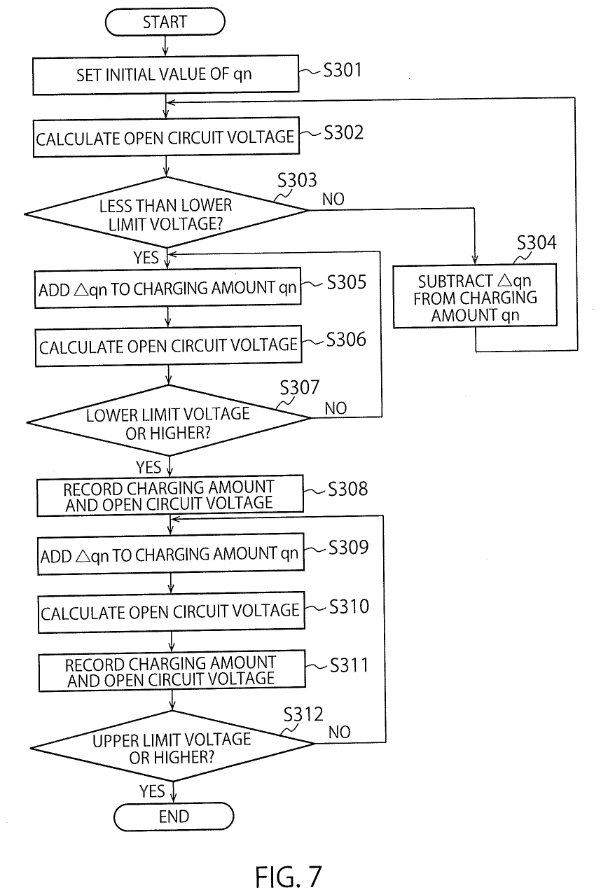

FIG. 7 is a flowchart illustrating an example of flow of a battery characteristics calculation process. This flowchart is started after the internal state parameters are calculated. In this flowchart, the charge amount “qₙ” is incremented/decremented by a constant value “Δqₙ,” a charge amount “qₙ₀” where the open circuit voltage increases from a value less than a lower limit value to a value equal to or greater than the lower limit value is found, and using “qₙ₀” as an initial value, “qₙ” is incremented by “Δqₙ” at a time until the open circuit voltage exceeds an upper limit value, and the charge amount and the open circuit voltage at that time are recorded for every increment. In this way, it is possible to calculate a relationship between the charge amount and the open circuit voltage within a range of the open circuit voltage from the lower limit value to the upper limit value. A difference between the charge amount “qₙ₀” and the charge amount “qₙ” when the open circuit voltage is the upper limit value becomes the battery capacity.

The deterioration state estimator 231 sets an initial value of the charge amount “qₙ” (S301). The initial value of “qₙ” may be set to “0” or to a value smaller than “0” by several percent of nominal capacity of the storage battery 1. More specifically, if the nominal capacity of the storage battery 1 is 1000 mAh, the initial value of qₙ may be set to a range on the order of −50 mAh to 0 mAh.

The deterioration state estimator 231 calculates an open circuit voltage (S302). The open circuit voltage can be calculated using the following Expression.

$$\begin{matrix}[ Expression 3 ] & \\ {E}_{n} = {f}_{c} ( {q}_{0}^{c} + \frac{{q}_{n}}{{M}_{c}} ) - {f}_{a} ( {q}_{0}^{a} + \frac{{q}_{n}}{{M}_{a}} ) & ( 3 )\end{matrix}$$

Next, the deterioration state estimator 231 compares the calculated open circuit voltage with a predetermined lower limit voltage (S303). The lower limit voltage is a value determined by a combination of a positive electrode active material and a negative electrode active material used for the storage battery 1. More specifically, from the standpoints of safety, life and resistance and the like, voltages within appropriate operating ranges of the respective standpoints are defined for the positive electrode active material and the negative electrode active material respectively, and a lower limit voltage and an upper limit voltage within the operating range as the storage battery 1 are determined by the combination thereof.

When the open circuit voltage is not less than the predetermined lower limit voltage (NO in S303), “Δqₙ” is subtracted from the charge amount “qₙ” (S304) and the open circuit voltage is calculated again (S302). When the open circuit voltage is less than the lower limit voltage (YES in S303), the deterioration state estimator 231 adds “Δqₙ” to the charge amount “qₙ” (S305). In this way, the charge amount “qₙ” approximates to the lower limit value. A value of Δqₙ can be freely determined. For example, “Δqₙ” may be possibly set to on the order of 1/1000 to 1/100 of a nominal capacity of the storage battery 1. More specifically, if the nominal capacity of the storage battery 1 is 1000 mAh, “Δqₙ” can be set to a range on the order of 1 mAh to 10 mAh.

The deterioration state estimator 231 calculates an open circuit voltage using the added charge amount “qₙ+Δqₙ” (S306). The deterioration state estimator 231 compares the calculated open circuit voltage with the aforementioned lower limit voltage (S307). When the open circuit voltage is less than the lower limit voltage (NO in S307), the flow returns to S305 and “Δqₙ” is added to the charge amount “qₙ” again (S305). When the open circuit voltage is equal to or higher than the lower limit voltage (YES in S307), since the open circuit voltage is increased from a value less than the lower limit value to a value equal to or higher than the lower limit value, the charge amount “qₙ” in this case is assumed to be “qₙ₀” and the charge amount “qₙ₀” and the open circuit voltage “En” are recorded together (S308). Incidentally, the value of this charge amount “qₙ₀” may be expressed as “0” as a reference value. In that case, a value obtained by subtracting the value of “qₙ₀” from the value of the charge amount “qₙ” is recorded when performing subsequent recordings.

The deterioration state estimator 231 adds “Δqₙ” to the charge amount “qₙ” (S309), calculates an open circuit voltage (S310), and records a value obtained by subtracting “qₙ₀” from the charge amount “qₙ” and the calculated open circuit voltage “En” (S311). The deterioration state estimator 231 compares the calculated open circuit voltage with a predetermined upper limit voltage of the storage battery 1 (S312). The upper limit voltage of the storage battery 1 is a value determined by a combination of the positive electrode active material and the negative electrode active material used for the storage battery 1. When the open circuit voltage is less than the predetermined upper limit voltage (NO in S312), the flow returns to the process of adding “Δqₙ” to the charge amount “qₙ” again (S309). When the open circuit voltage reaches or exceeds the predetermined upper limit voltage (YES in S312), the process ends. This is the flowchart showing the battery characteristic calculation processing flow.

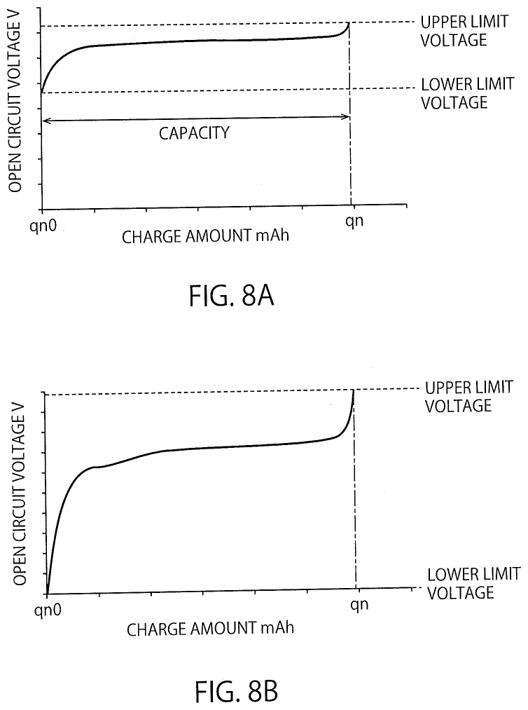

FIGS. 8A and 8B are a graph illustrating an example of a relationship between the charge amount and the open circuit voltage (charge amount-OCV curve). FIG. 8A is a charge amount-OCV curve calculated by the deterioration state estimator 231. FIG. 8B is a diagram in which the vertical axis of the graph shown in FIG. 8A is adapted so as to range from the lower limit voltage to the upper limit voltage. Thus, the deterioration state estimator 231 calculates necessary internal state parameters or battery characteristics.

The SOC information estimator 232 estimates information of the SOC of the storage battery 1 based on the internal state parameters and battery characteristics and the like calculated by the deterioration state estimator 231. More specifically, the SOC information estimator 232 estimates a correspondence relationship between each two of the voltage, current, and SOC of the storage battery 1.

For example, the SOC information estimator 232 converts the charge amount-OCV curve calculated by the deterioration state estimator 231 to an SOC-OCV curve. The conversion from the charge amount to the SOC may be performed using the battery capacity and the charge amount calculated from the charge amount-OCV curve. The open circuit voltage can be expressed by voltage+c×internal resistance×current (open circuit voltage=voltage+c×internal resistance×current). Symbol “c” represents a predetermined constant. Therefore, the SOC can be calculated from the voltage and current values included in the measurement data.

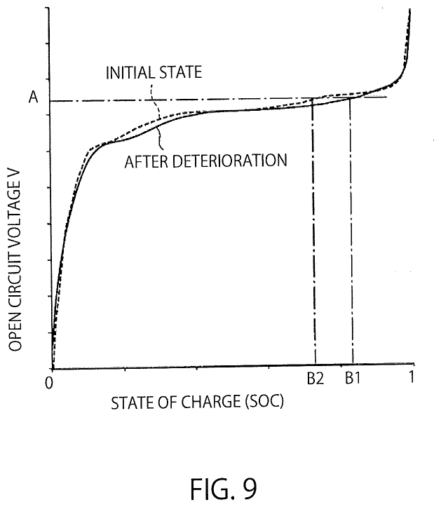

FIG. 9 is a graph illustrating an example of a relationship between an SOC and an open circuit voltage (SOC-OCV curve). FIG. 9 is different from FIGS. 8A and 8B in that the horizontal axis represents not the charge amount but the SOC. FIG. 9 shows the graph shown in FIG. 8B converted to an SOC-OCV curve (solid line) superimposed on a graph (broken line) of the SOC-OCV curve of the storage battery 1 at an initial state. That is, the broken line in FIG. 9 represents an open circuit voltage of the storage battery 1 at the initial state and the solid line represents an open circuit voltage of the storage battery 1 after a change (current value) due to deterioration or the like of the storage battery 1. The SOC represents a proportion of the charge amount being currently charged with respect to the full charging capacity, and is expressed by values between 0 and 1 or between 0% and 100%.

The curve after the change becomes shorter as the capacity decreases, but it is seen from FIG. 9 that not only the length of the curve but the shape itself changes. For example, when the open circuit voltage is A, the SOC is “B1.” However, if the open circuit voltage is determined from the SOC-OCV curve at the initial state, the SOC is determined as “B2,” causing the estimation accuracy of the SOC to deteriorate. Therefore, the SOC can be calculated accurately from the voltage and current included in measurement data using the SOC-OCV curve in the current state of the storage battery 1.

In the present embodiment, as described in FIG. 4, charging is stopped based on the SOC of the storage battery 1 in charging. Therefore, if the SOC of the storage battery 1 cannot be estimated accurately, there can also be a situation in which it may not be possible to detect that an upper limit value of the SOC is reached. Hence, a stoppage of charging after exceeding the upper limit value of the SOC may occur. Therefore, it is preferable to estimate the correspondence relationship at this time between each of the voltage, current and SOC of the storage battery 1 through a charge curve analysis.

Incidentally, although a case has been described above where the positive electrode and the negative electrode of the secondary battery are each made of one type of active material, the present embodiment is also likewise applicable to a secondary battery, any one or both of the positive electrode and the negative electrode of the secondary battery of which is/are made of a plurality of active material.

Although an estimate value calculated as an internal state parameter can be used for the internal resistance, the internal resistance varies depending on temperature or the like. Therefore, the deterioration state estimator 231 may correct the internal resistance. Furthermore, the deterioration state estimator 231 may also recalculate the once calculated battery characteristic using the corrected estimate value. This makes it possible to improve the accuracy of estimation of a deterioration state.

The internal resistance can be corrected using a known technique described in Japanese Unexamined Patent Application Publication No. 2017-166874 or the like. For example, internal resistance corresponding to temperature can be calculated: by dividing the internal resistance into three components (reaction resistance “R_{ct}”, diffusion resistance “R_{d}”, and ohmic resistance “Rₒₕₘ”); by correcting the three components according to respective unique temperature dependencies; and by summing up the components.

The upper limit value determiner 24 determines the upper limit value of the SOC when charging and use of the battery are simultaneously performed based on information on the storage battery 1. Incidentally, the upper limit value determiner 24 may be omitted when no upper limit value of the SOC is determined according to the storage battery 1.

The upper limit value of the SOC may also be determined (calculated) based on a relational expression or graph between a parameter indicating a deterioration state and an upper limit value of the SOC. Alternatively, parameter values indicating deterioration states may be classified into a predetermined (plural) number of ranges and an upper limit value of the SOC may be determined based on a correspondence table indicating a correspondence relationship between the classification and an upper limit value of the SOC. For parameters indicating the deterioration state, parameters (internal state parameters and battery characteristics) calculated in the process of estimating a correspondence relationship with the SOC may be used, and it may be determined in advance as to what parameters should be used. Alternatively, a plurality of parameters may be selected freely. It is preferable to prevent deterioration from progressing as much as possible by lowering the upper limit value of the SOC of the storage battery 1 having greater deterioration.

Furthermore, the temperature of the storage battery 1 or the periphery thereof may also be taken into consideration in determining the upper limit value. When the temperature is higher than a predetermined threshold, the upper limit value of the SOC may be reduced. In this case, data indicating a deterioration characteristic of the battery during storage such as a correlation between the battery deterioration speed and the SOC and a correlation between the deterioration speed and a temperature may be referred to.

The upper limit value determiner 24 may change the upper limit value every time charging is performed. For example, as shown in FIG. 4, the upper limit value may be decreased by on the order of several percent every time charging is performed until a charging count exceeds a predetermined threshold. Then, the upper limit value may be fixed when the charging count exceeds the predetermined threshold.

The determiner 25 determines whether or not the storage battery 1 is being used in charging of the storage battery 1. The determiner 25 may determine the use of the storage battery 1 from a fluctuation of a measured value included in the measurement data. For example, when a voltage of the storage battery 1 has become lower than a predetermined value within a predetermined time period, it can be determined that the storage battery 1 is being used. On the other hand, when a temperature of the storage battery 1 has not become lower than a predetermined value within a predetermined time period, it can be determined that the storage battery 1 is being used.

The determiner 25 determines a resumption of charging while charging is stopped. Charging is resumed when the voltage indicated in measurement data has become lower than a predetermined threshold. Charging is also resumed when use of the storage battery 1 is stopped. A method for determining whether or not to stop use of the storage battery 1 may be the same as the method for determining whether the storage battery 1 is being used. The determination result by the determiner 25 is sent to the charge controller 21 and the charge controller 21 controls charging based on the determination result.

Incidentally, use or not use of the storage battery 1 may be notified from outside. The determiner 25 may determine use or not use of the storage battery 1 based on the notification. For example, use of the storage battery 1 may be notified, via an electric signal or communication signal, from an application being executed on a smartphone that uses the storage battery 1 as a power source.

The detector 26 detects that the SOC of the storage battery 1 has reached the upper limit value. The detection may be performed based on measurement data. For example, the detector 26 calculates a present SOC of the storage battery 1 from the voltage and current values included in the measurement data, using information on a correspondence relationship with the SOC calculated by the SOC information estimator 232. The detector 26 may detect that the calculated SOC value has reached the upper limit value.

The data storage (reference data acquirer) 27 stores data to be used for processing by the charge control device 2. For example, reference data such as a relational expression, graph and correspondence table used when calculating an upper limit value of the SOC may be stored.

When a plurality of pieces of reference data relating to the upper limit value are stored in the data storage 27, the upper limit value determiner 24 may extract reference data suited to the storage battery 1 and calculate an upper limit value using the reference data. This makes it possible to set an upper limit value more suited to the storage battery 1. Although the upper limit value has been set using reference data based on the deterioration state of the storage battery 1 in the description so far, appropriate upper limit values may also differ depending on a standard and history and the like of the storage battery 1 such as the type, the number of years in use, date of manufacturing, manufacturing vendor even when the storage battery 1 is in the same deterioration state. Therefore, the upper limit value determiner 24 preferably acquires reference data to determine the upper limit value based on information on the storage battery 1 such as the standard, history parameters indicating a deterioration state.

Suppose that the reference data has been created in advance based on a plurality of secondary batteries that satisfy prerequisites. The reference data is generally used for other secondary batteries that satisfy the prerequisites. The prerequisites are not particularly limited but a variety of prerequisites are assumed to exist. For example, the prerequisites can be such that the material used for the electrodes of the secondary battery and the amount of active material of the electrodes should fall within a predetermined range. Incidentally, the method for creating reference data is not particularly limited but may be determined freely.

Furthermore, the data storage 27 may acquire reference data from a device or the like that provides reference data via wired or wireless communication or an electric signal based on information on the storage battery 1. The device or the like that provides reference data is not particularly limited. It may be an external database storing the reference data or a reference data supplying server that generates and supplies reference data.

Timing for acquiring reference data is not particularly limited. Reference data may be acquired irregularly or regularly, for example, when no corresponding reference data is found in the storage battery 1 or when the reference data supplying device generates new reference data. When no appropriate reference data is found in the data storage 27, reference data corresponding to them may be acquired based on the aforementioned prerequisites or the like. Alternatively, all reference data supplied from the reference data supplying device may be acquired. Incidentally, reference data regarded as unnecessary among the acquired reference data may not have to be stored in the data storage 27.

Incidentally, the reference data that has been stored in the data storage 27 may be deleted. For example, reference data satisfying predetermined deletion conditions, such as reference data infrequently used and reference data whose expiration date is exceeded, may be deleted from the data storage 27 for saving capacity.

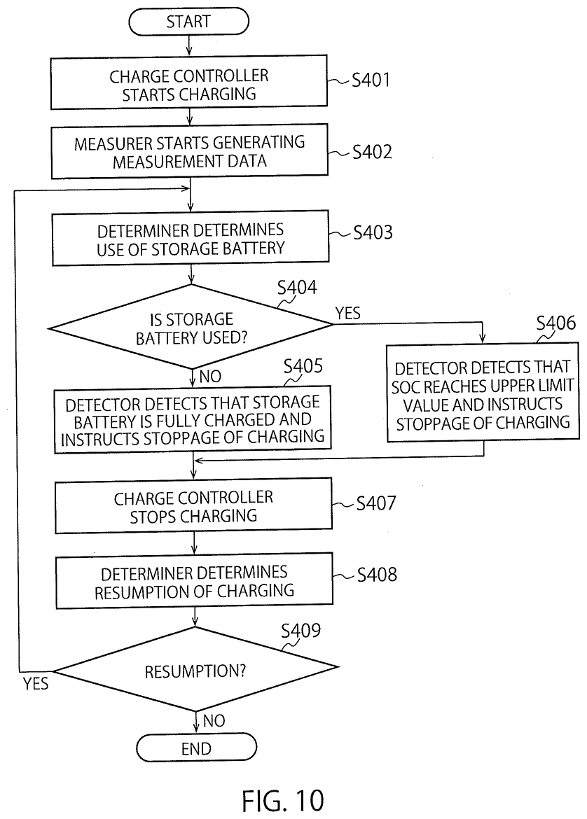

The processing flow by the charge controller 21 after the upper limit value determiner 24 determines the upper limit value will be described. FIG. 10 is a flowchart illustrating an example of a flow of charge control by the charge controller 21. The flow is started when the charge controller 21 receives a charging execution command. Incidentally, suppose that the charge controller 21 has already received an upper limit value.

The charge controller 21 starts charging (S401). The measurer 22 starts generating measurement data (S402). Hereinafter, the determiner 25 and the detector 26 can refer to measurement data in real time. The determiner 25 determines use of the storage battery 1 based on the measurement data (S403). Incidentally, the determiner 25 may determine use of the storage battery 1 based on a report from outside.

When it is determined that the storage battery 1 is not being used (NO in S404), charging progresses until the storage battery 1 is fully charged, the detector 26 detects that the storage battery 1 is fully charged and instructs the charge controller 21 to stop charging (S405). On the other hand, when it is determined that the storage battery 1 is being used (YES in S404), charging progresses until the SOC of the storage battery 1 reaches an upper limit value. Then, the detector 26 detects that the SOC has reached the upper limit value and instructs the charge controller 21 to stop charging (S406). That is, at a time point at which it is detected that the SOC has reached the upper limit value, the charge controller 21 stops charging of the storage battery 1.

The charge controller 21 receives the instruction from the detector 26 and stops charging (S407). After stoppage of charging, the determiner 25 determines a resumption of charging (S408). The determination may be made based on the measurement data or based on a report from outside. When it is determined that charging is resumed (YES in S409), the determiner 25 determines use of the storage battery 1 again (S403). Therefore, when it is determined that the storage battery 1 is being used even after the resumption of charging, the stoppage and resumption of charging as shown in FIG. 4 are repeated. On the other hand, when it is determined that the storage battery 1 is not being used after the resumption of charging, charging of the storage battery 1 is resumed and the battery can be charged until it is fully charged. When it is determined that charging is not resumed (NO in S409), the flow ends. For example, at a time point at which an electrical connection between the charge control device 2 and the storage battery 1 is canceled, the determiner 25 may determine not to resume charging.

Incidentally, the charge controller 21 counts a charging count when charging is resumed, the charge controller 21 may use an upper limit value corresponding to the count. In this way, it is possible to perform processing of gradually lowering an upper limit value as shown in FIG. 4.

As described above, according to the present embodiment, when the storage battery 1 is used while being charged, charging is stopped before the storage battery 1 is fully charged and the SOC is suppressed. This makes it possible to prevent deterioration by use of the storage battery 1 while being charged.

According to the present embodiment, it is possible to improve the accuracy of SOC estimation of the storage battery 1 by using a charge curve analysis. This makes it possible to stop charging when the SOC of the storage battery 1 reaches a desired value.

Furthermore, according to the present embodiment, the deterioration state of the storage battery 1 is taken into consideration and the upper limit value is determined. This makes it possible to restrict the SOC to a level appropriate for the storage battery 1.

Incidentally, the above-described system configuration is an example and the system configuration is not limited to the above-described configuration. For example, some components of the charge control device 2 can be located outside the charge control device 2 if information necessary for processing can be received from the charge control device 2 through communication signal or an electric signal and the processing result can be handed over to the charge control device 2. For example, an estimation device provided with the estimator 23 may be located outside the charge control device 2.

Furthermore, the respective processes in the above-described embodiment may be implemented by a dedicated circuit or implemented using software (a program). When software (a program) is used, according to the above-described embodiment, it is possible to implement the processes using, for example, a general-purpose computer apparatus as basic hardware and causing a processor such as a central processing unit (CPU) mounted on the computer apparatus to execute a program.

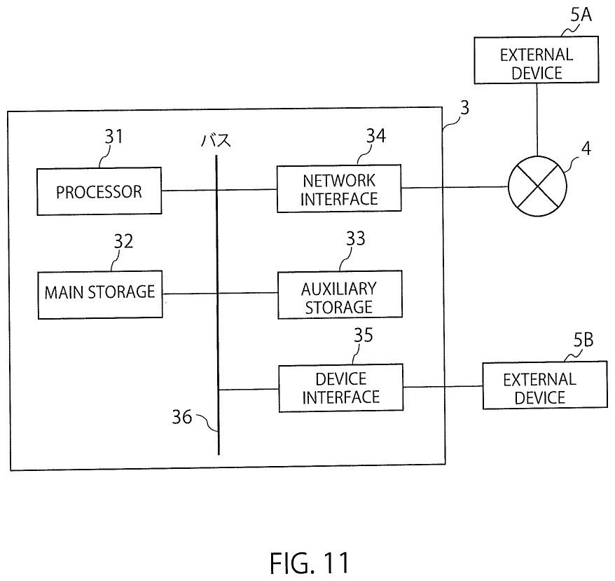

FIG. 11 is a block diagram illustrating an example of a hardware configuration according to an embodiment of the present invention. The charge control device 2 can be implemented as a computer apparatus 3 provided with a processor 31, a main storage 32, an auxiliary storage 33, a network interface 34 and a device interface 35, all of which are connected via a bus 36.

The processor 31 reads a program from the auxiliary storage 33, develops the program on the main storage 32 and executes the program, and can thereby implement each function of each component of the charge control device 2.

The processor 31 is an electronic circuit including a control device and a calculation device of a computer. For the processor 31, it is possible to use, for example, a general-purpose processor, a central processing unit (CPU), a microprocessor, a digital signal processor (DSP), a controller, a microcontroller, a state machine, an application specific integrated circuit, a field programmable gate array (FPGA), a programmable logic device (PLD), and a combination of these components.

The charge control device 2 according to the present embodiment may also be implemented by pre-installing a program to be executed by each device in the computer apparatus 3. Alternatively, the charge control device 2 may also be implemented by installing a program stored in a storage medium such as a CD-ROM or a program distributed via a network in the computer apparatus 3 as appropriate.

The main storage 32 is a memory device that temporarily stores instructions to be executed by the processor 31 and various kinds of data or the like, and may be a volatile memory such as a DRAM or a non-volatile memory such as an MRAM. The auxiliary storage 33 is a storage device that permanently stores programs and data, and may be a flash memory or the like.

The network interface 34 is an interface to make connections with a communication network 4 through wireless or wired communication. The network interface 34 allows the computer apparatus 3 to be connected to an external device 5A via the communication network 4. For example, when the reference data acquirer carries out communication with a reference data supplying device such as a cloud, the external device 5A corresponds to the reference data supplying device.

The device interface 35 is an interface such as a USB that makes a direct connection with an external device 5B. That is, the computer apparatus 3 can be connected to the external device 5 via a network or can be connected directly. The external device 5 (5A and 5B) may be any one of an external device of the charge control device 2, an internal device of the charge control device 2, an external storage medium and a storage device. When the reference data acquirer acquires reference data from an external storage medium or storage device via the device interface 35, the external device 5B corresponds to the reference data supplying device.

Incidentally, the external device 5 may be an input device or an output device. The input device includes devices such as a keyboard, a mouse, a touch panel and gives information inputted through these devices to the computer apparatus 3. Signals from the input device are outputted to the processor 31.

The computer apparatus 3 may be constructed of dedicated hardware such as a semiconductor integrated circuit mounted with the processor 31 or the like. The dedicated hardware may be constructed of a combination with a storage device such as a RAM and a ROM. The computer apparatus 3 may be incorporated in the storage battery 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A charge control device comprising:
a charge controller configured to control charging of a secondary battery; and
a determiner configured to determine whether or not the secondary battery is being used in charging of the secondary battery, wherein
when it is determined that the secondary battery is being used, the charge controller stops charging of the secondary battery before the secondary battery is fully charged.

2. The charge control device according to claim 1, wherein
when it is determined that the secondary battery is not used after stopping charging of the secondary battery before the secondary battery is fully charged, the charge controller resumes charging of the secondary battery so that the secondary battery is fully charged.

3. The charge control device according to claim 1, further comprising a detector configured to detect that a state of charge of the secondary battery reaches an upper limit value, wherein
when it is determined that the secondary battery is being used, if it is detected that the state of charge of the secondary battery reaches an upper limit value, the charge controller stops charging of the secondary battery.

4. The charge control device according to claim 3, further comprising a measurer configured to generate measurement data at least indicating a voltage and current of the secondary battery in charging or discharging of the secondary battery, wherein
the detector detects that the state of charge of the secondary battery reaches the upper limit value from a value of a voltage and a value of a current indicated in the measurement data in charging of the secondary battery, using information on a correspondence relationship between each two of a voltage, a current and a state of charge of the secondary battery.

5. The charge control device according to claim 4, further comprising an estimator configured to:
calculate respective initial charge amounts and masses of a positive electrode and a negative electrode of the secondary battery based on measurement data in charging or discharging of the secondary battery,
calculate a function for indicating a relationship between an open circuit voltage of the secondary battery and a state of charge of the secondary battery based on the calculated respective initial charge amounts and masses of the positive electrode and the negative electrode of the secondary battery, and
estimate the correspondence relationship based on the function.

6. The charge control device according to claim 3, further comprising an upper limit value determiner that determines the upper limit value based on information on the secondary battery.

7. The charge control device according to claim 5, further comprising an upper limit value determiner configured to determine the upper limit value based on parameters calculated in the process of estimating the correspondence relationship.

8. The charge control device according to claim 6, further comprising a reference data acquirer configured to acquire, based on the information on the secondary battery, reference data for determining the upper limit value, wherein
the upper limit value determiner determines the upper limit value using the reference data.

9. A charge control method comprising:
starting charging a secondary battery;
determining whether or not the secondary battery is being used in charging of the secondary battery; and
stopping charging the secondary battery before the secondary battery is fully charged when it is determined that the secondary battery is being used.

10. A non-transitory computer readable medium having a program for causing a computer to execute:
starting charging a secondary battery;
determining whether or not the secondary battery is being used in charging of the secondary battery; and
stopping charging of the secondary battery before the secondary battery is fully charged when it is determined that the secondary battery is being used.

11. A control circuit comprising:
a charge controller configured to control charging of a secondary battery; and
a determiner configured to determine whether or not the secondary battery is being used in charging of the secondary battery, wherein
when it is determined that the secondary battery is being used, the charge controller stops charging the secondary battery before the secondary battery is fully charged.

12. A power storage system comprising:
a secondary battery; and
a charge control device, wherein
the charge control device comprises:
a charge controller configured to control charging of the secondary battery; and
a determiner configured to determine whether or not the secondary battery is being used in charging of the secondary battery, and
when it is determined that the secondary battery is being used, the charge controller stops charging the secondary battery before the secondary battery is fully charged.
